(19) United States
(12) Patent Application Publication
(10) Pub. No.: US 2026/0096535 A1
(43) Pub. Date: Apr. 9, 2026

(54) BACKPACK FOR CARRYING ANIMALS

(71) Applicant: LITTLE CHONK COMPANY, Brooklyn, NY (US)

(72) Inventors: Bryan REISBERG, Brooklyn, NY (US); Scott DUNN, Brooklyn, NY (US)

(73) Assignee: LITTLE CHONK COMPANY, Brooklyn, NY (US)

(21) Appl. No.: 19/259,243

(22) Filed: Jul. 3, 2025

Related U.S. Application Data
(60) Provisional application No. 63/667,188, filed on Jul. 3, 2024.

(51) Int. Cl. A01K 1/02; A45F 3/00; A45F 3/04

(52) U.S. Cl. CPC A01K 1/029; A45F 3/047; A45F 2003/003; A45F 2003/045

(57) ABSTRACT

A backpack for carrying pets is provided including a main body having a compartment for carrying a pet, a height adjustable shoulder strap system attached to the main body, a brace attached to the back of the main body, and a harness attached to the brace so that a hole or holes are formed between the harness and a top portion of the main body, allowing the limbs of the pet to protrude from the front of the backpack. The backpack includes rigidity bars that can interlock with the shoulder strap system to provide rigidity to the backpack, so that larger pet breeds can be carried. The main body and brace provide rigidity and adjustable compression to allow the pet to sit up in the main body when carried in the backpack. The main body has multiple entry and exit points for loading and unloading the pet.

### CROSS-REFERENCE TO A RELATED APPLICATION

The present application claims priority based on U.S. Provisional Application No. 63/667,188, filed Jul. 3, 2024, the disclosure of which is incorporated herein by reference in its entirety.

### 1. FIELD OF THE DISCLOSURE

The present disclosure relates to a backpack for carrying animals. More particularly, the present disclosure relates to a backpack for carrying pets in a main compartment or main body of the backpack, with the backpack having a height adjustable shoulder strap system, bars for added rigidity, and an adjustable chest harness for the pet, that allows the front limbs of the pet to protrude outside the backpack compartment or main body.

### 2. Description of the Related Art

Current backpacks for carrying pets have two holes for the front limbs of the pet to protrude through the backpack compartment in an attempt to increase the comfort of the pet. In some known backpacks, these two holes are made in the main backpack compartment, just above the shoulder straps of the backpack, and the holes are made in the same backpack panel that rests on a user's back. However, as these holes are always spaced apart at the same fixed length from each other, and in the same fixed location on the backpack. Since each pet is a unique shape and size, these holes may not line up perfectly with the limbs of each pet. Limbs can vary in size and the placement of the limbs relative to the width of the chest of the pet can vary as well. Forcing or placing the pets' limbs through these fixed separate holes may cause discomfort to the pet when the holes do not align properly with the size and shape of the pet's limbs. In some known backpacks, these holes are relatively small when compared to the size of the panel in which they are made, which raises the difficulty of placing the limbs of pets of different sizes through these holes.

Current backpacks have bodies or compartments that do not provide enough rigidity or adjustable compression to allow the pet to comfortably sit upright within the pack when being carried. The problem of lacking rigidity is especially apparent when using backpacks to carry heavier pets, such as medium to larger breeds of dogs.

Backpacks lacking sufficient rigidity can cause the backpack to deform, crumple, or collapse under load, and cause both the pet, and the human user unnecessary and premature fatigue.

Current backpacks do not have multiple entry and exit points on the pack body or main compartment of the pack to allow the easy loading and unloading of a pet.

Current backpacks also lack multiple handles located at various convenient locations on the pack body, which makes handling the pack when loading, unloading, or picking up or putting down the pack with the pet difficult.

Current backpacks do not have a brace that provides support for a pet's neck, and/or upper body which can cause discomfort to a pet, since the neck or upper body of the pet may sway back and forth due to momentum when the pet is being carried.

Current backpacks do not have an adjustable height system for the shoulder straps for enabling greater user comfort and adjustability, and that can also provide added rigidity for carrying heavier pets.

Current backpacks do not have an adjustable chest harness that can help keep the pet comfortably in place when the pet is loaded into the backpack.

Current backpacks do not have an adjustable chest harness that allows for plenty of space for the front limbs of the pet to protrude from the front of the backpack to face the user, so that the space accommodates pets of different sizes and chest widths.

Current backpacks do not have an adjustable chest harness that when in use, provides either a single space or two spaces for the front limbs of pets of varying sizes to protrude out of the backpack.

Additionally, a backpack that addresses or mitigates all or some of these aforementioned issues does not exist.

Thus, there is a need to address the above-mentioned problems.

### SUMMARY OF THE DISCLOSURE

The present disclosure provides a backpack that addresses all or virtually all of the aforementioned and other shortcomings of current backpacks for carrying animals and pets.

The present disclosure provides for a backpack (“pack”) having multiple entry and exit points for easy loading and unloading of a pet into and out of the pack. Thus, the present disclosure additionally provides for a method to load and unload pets easily from the backpack disclosed herein.

The present disclosure also provides for such a pack that has space for the pet's front limbs to comfortably protrude from the pack.

The present disclosure also provides for such a pack that has enough rigidity and/or adjustable compression to enable a pet, including larger breeds of pets to comfortably sit up in the pack when loaded into the pack, and when carried. The present disclosure also provides for such a pack that has enough rigidity and/or adjustable compression to prevent and/or reduce collapsing or crumpling of the backpack when in use and under load.

The present disclosure still further provides for such a pack that has multiple handles located at convenient locations on the pack, which gives a user the ability to grab one or multiple areas of the pack when loading and unloading the pet into the pack and picking up or putting down the pack thereby increasing the ease of using the pack.

The present disclosure also provides for an embodiment in which the pack has a brace at the top of the pack that provides support for a pet's neck, and/or upper body.

The present disclosure also provides for such a pack that has breathable mesh at one or locations on the pack to allow ventilation of heat from the pack and prevents excess heat buildup inside the pack, thereby providing additional comfort to the pet.

The present disclosure provides for a pack with embodiments that can combine all or some of these aforementioned features.

### BRIEF DESCRIPTION OF THE DRAWINGS

FIG. 1 is a back perspective view illustrating an embodiment of the backpack for carrying animals.

FIG. 2A is a left side view of the backpack as shown in FIG. 1.

FIG. 2B is a right-side view of the backpack as shown in FIG. 1.

FIG. 3 is a back view of the backpack as shown in FIG. 1.

FIG. 4 is a back view of the backpack as shown in FIG. 1.

FIG. 5 is a top view of the backpack as shown in FIG. 1.

FIG. 6 is a bottom view of the backpack as shown in FIG. 1.

FIG. 7 is a view of an interior of the front panel of the backpack.

FIG. 8 is a view of an interior of the right-side panel of the backpack.

FIG. 9 is a view of an interior of the front panel of the backpack.

FIG. 10 is a top view of a shoulder strap system.

FIG. 11 is a bottom view of a shoulder strap system.

FIG. 12 is a partial left-side view of the backpack of FIG. 1, showing the main compartment in an expanded state.

FIG. 13A is a front view of an embodiment of the chest harness.

FIG. 13B is a back view of the chest harness as shown in FIG. 13A.

FIG. 13C shows another embodiment of a chest harness.

FIG. 14 shows a series of steps for attaching the shoulder strap system to the front panel of the backpack of FIG. 1.

FIG. 15 shows a series of steps for inserting rigidity bars into an internal portion of the front panel of the backpack that also connects the shoulder strap system to the backpack.

FIG. 16 shows the shoulder strap system being adjusted to different heights.

### DETAILED DESCRIPTION

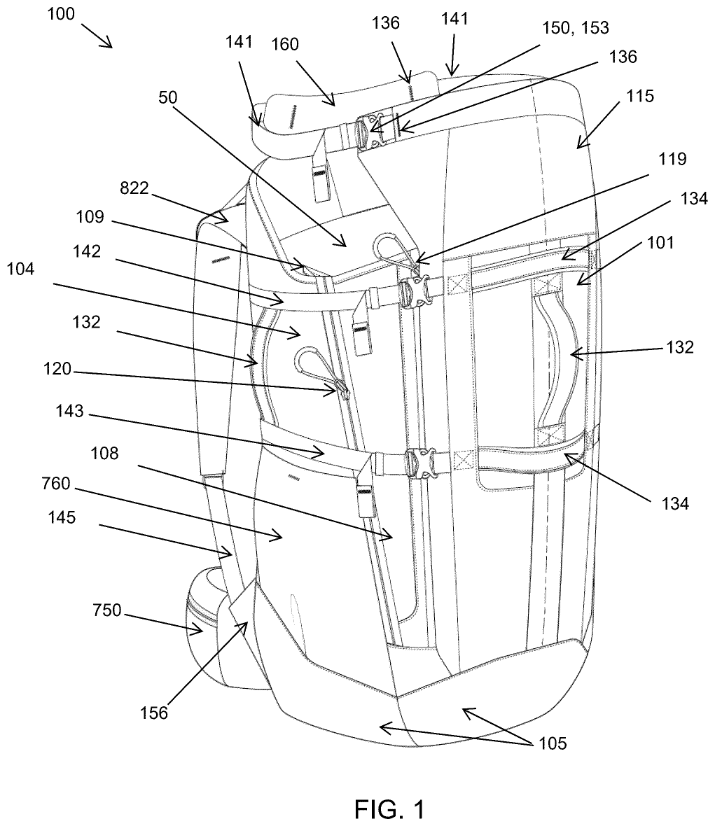

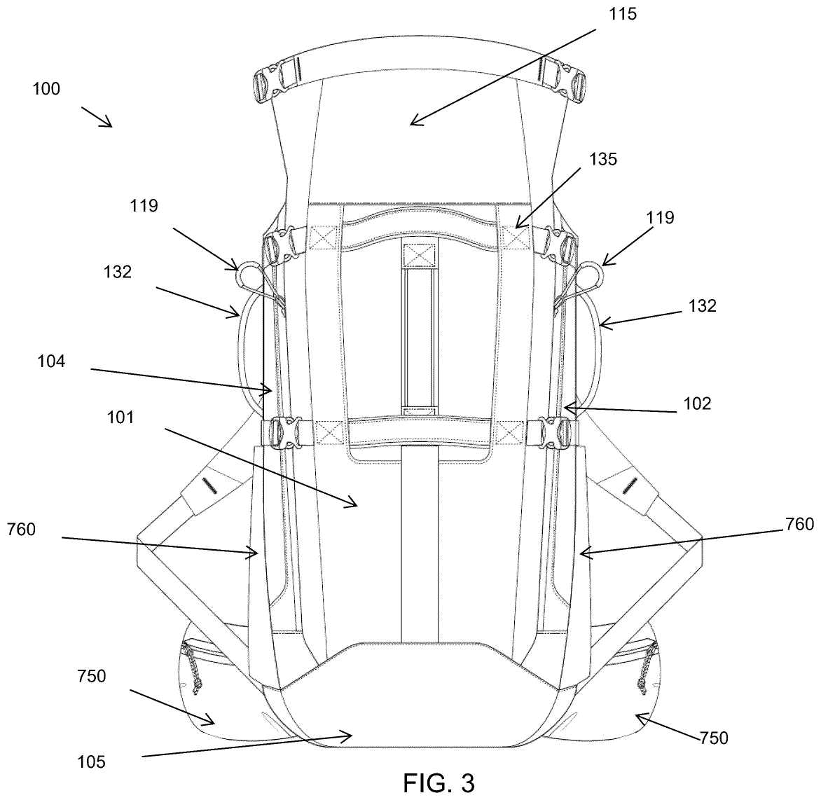

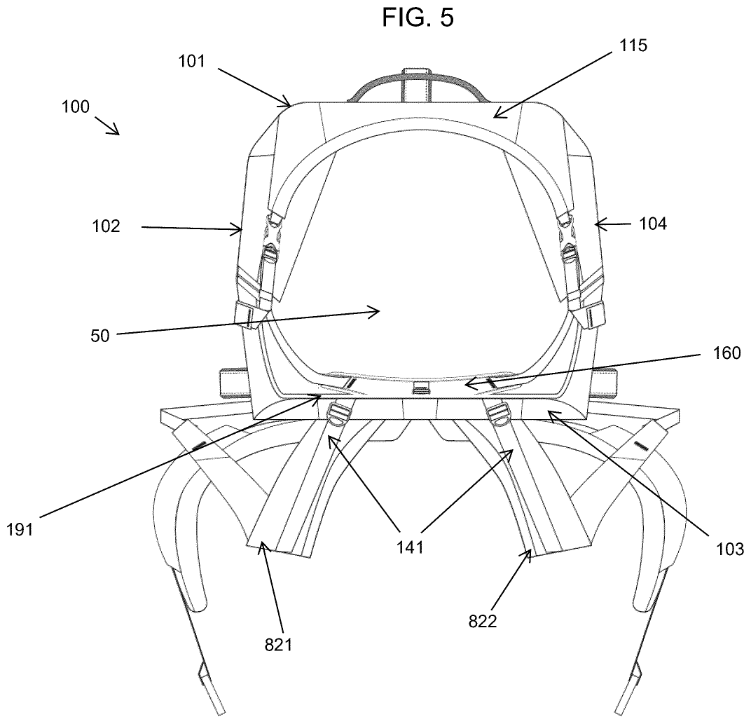

FIG. 1 shows a backpack of the present disclosure generally represented by reference numeral 100. In some embodiments, such as shown in FIGS. 1-6, backpack 100 has a main body 50 that can be composed of a number of panels, such as back panel 101, front panel 103 and side panels 102 and 104, and bottom panel 105. When panels 101-105 are connected or attached together through various methods, such as but not limited to, sewing, bar tacks, adhesives, fabric welding (which utilizes heat and pressure to join pieces of fabrics), and other such methods well known in the art, the panels form the main body or main compartment 50 as shown in FIG. 1.

In some embodiments, backpack 100 can be formed as a singular unitary piece or container that does not require separate panels, but still provides a main body portion 50. This single unitary embodiment of main body portion 50 has the same function and strap attachments, chest harness attachments, shoulder strap attachments, brace and shoulder height adjustment and rigidity system as the embodiment of main body 50 that is composed of separate panels.

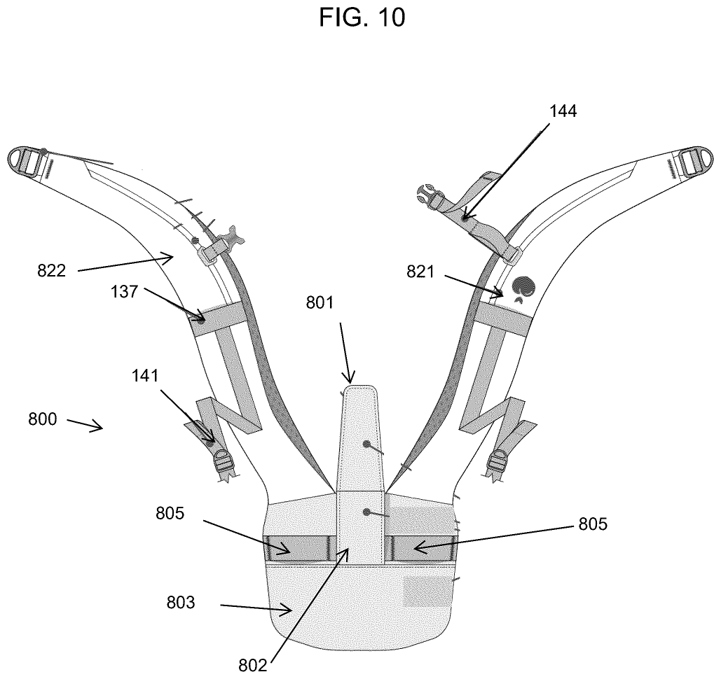

Referring to FIGS. 1-6, shoulder straps 821 and 822 are connected to front panel 103 by removable attachment of the shoulder strap system 800 described below with regards to FIGS. 10-15.

In an embodiment of the present disclosure shown in FIGS. 1-6, there is a brace 115. Brace 115 is a semicircular structure. Brace panel 115 is an extension of back panel 101. Brace 115 can rigid or semi rigid and prevents and/or mitigates the swaying motions of the upper body and/or neck area of a pet, when the pet is carried in the pack 100. Brace 115 also enhances the rigidity of the pack 100 and allows a pet to sit up easier in the pack 100 when being carried.

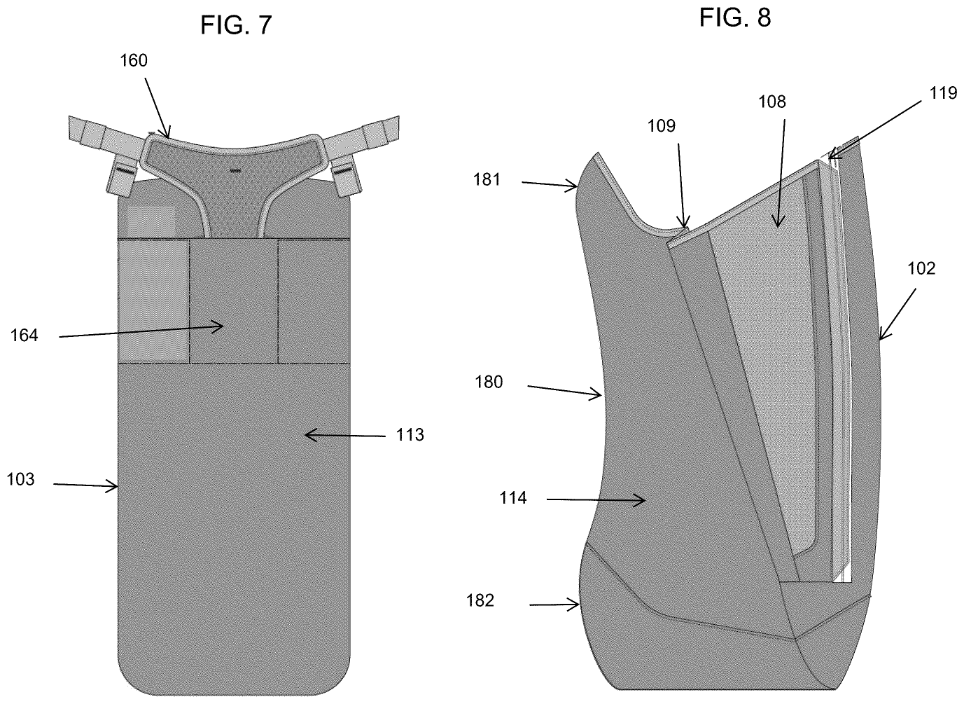

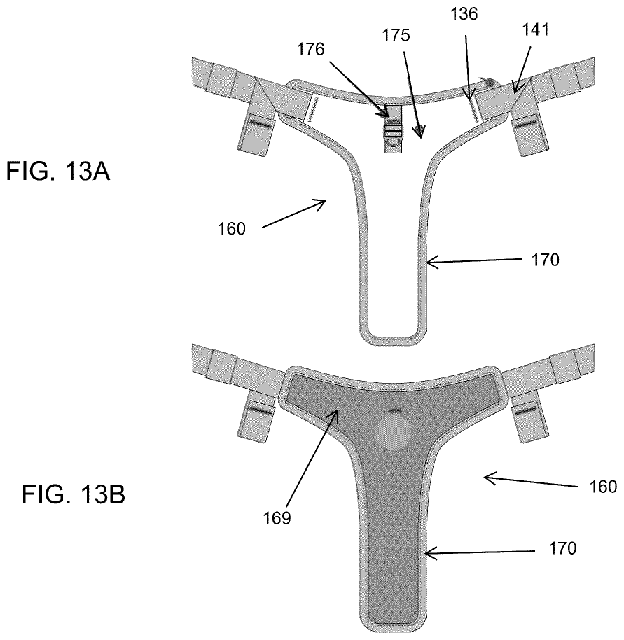

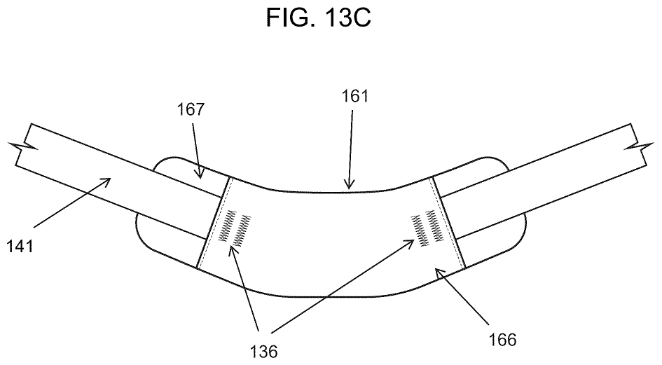

A harness, such as chest harness 160, is connected to the brace 115, as shown in FIGS. 1-6, by two nylon webbing straps 141. Straps 141 connect chest harness 160 to brace 115, via female and male connecters 150, 153. In some areas straps 141 are connected to brace 115 and harness 160 by stitching or bar tack 136 as shown. Bar tacks 136 can be a series of stiches used to reinforce areas and connect separate layers of fabric together. Straps 141 can be provided with extra length, for adjustability. The length of each strap 141 can be adjusted, such as by a webbing slider or other means, to allow for adjustments of chest harness 160 allowing for a tighter or loser fit. Harness 160 provides compression and support to the upper chest and/or neck area of pet, when connected to brace 115. Harness 160 is further described below with regards to FIGS. 7, 13A and 13B. FIG. 13C described below provides another embodiment of the chest harness, being chest harness 161.

When harness 160 or 161 is connected to brace 115, two holes 193 or a single hole are created between an upper lip 191 near a top portion of front panel 103, and harness 160 or 161 respectively, and brace 115.

When harness 160 is connected to brace 115, and to an interior pocket of panel 103, as shown in FIG. 7, the two holes 193 define two paw portals. The paw portals 193 allow the front limbs of a pet to protrude out of pack 100 and towards the back of a user when the pack 100 is loaded with the pet therein and a user puts their arms through the shoulder straps 821 and 822 onto his/her back. When harness 161 is connected to brace 115, the singular hole defines a single paw portal area, through which the front limbs of a pet are able to protrude out of pack 100 and towards the back of a user when the pack 100 is loaded with the pet therein and a user puts their arms through the shoulder straps 821 and 822 onto his/her back.

When harness 160 is used, the two paw portals 193 are advantageous over known packs for carrying animals since the paw portals 193, are not formed within the main compartment 50, and are also not formed in the wall of a panel such as panel 103. In known packs, where holes are formed into the wall of the panel, these panels could have lower rigidity or structural stability, due to these holes.

When harness 160 is used, each front limb of the pet can fit in each paw portal 193, which provide plenty of room for pets of different sizes, since the portals 193 are large. In known packs that have two separate holes formed in the main pack 100, (for example if formed in the top of panel 103), these holes are in fixed locations no matter the size and shape of the pet. The fixed locations of the separate holes in known packs can cause pets discomfort by forcing limbs into awkward angles and positions when the separate holes for each limb do not align with limbs of the pet. In contrast, the larger paw portals 193 that are not formed in a panel wall, provide increased comfort to the pet, since the paw portals are large enough to accommodate a range of pets with different dimensions and limb sizes in the pack 100.

When harness 161 is used, the singular paw portal is advantageous over known packs for carrying animals since the paw portal does not use separate holes that are formed in the panel 103 or the main compartment 50 of pack 100. Both front limbs of a pet can fit in the singular paw portal. In known packs that have two separate holes formed in the main pack 100, (for example if formed in the top of panel 103), these holes are in fixed locations no matter the size and shape of the pet. The fixed locations of the separate holes in known packs can cause pets discomfort by forcing limbs into awkward angles and positions when the separate holes for each limb do not align with limbs of the pet. In contrast, a larger singular paw portal provides increased comfort to the pet, since the paw portal is large enough to accommodate a range of pets with different dimensions and limb sizes in the pack 100.

Backpack 100 has handles 132 and 134 spaced apart on different areas of the pack 100 to increase the ease of handling and using the pack, namely when a user raises or lowers, or loads or unloads, a pet into and out of the pack 100. Handles 132 are oriented vertically, with respect to the pack 100, while handles 134 are oriented horizontally with respect to pack 100. In some embodiments, pack 100 can have three handles 132, with a handle on panel 101, 102 and 104 as shown in FIGS. 1-6. In some embodiments, pack 100 can have two handles 134, with the handles on panel 101, as shown in FIGS. 1-6. Handles 132 and 134 will be described further below.

Backpack 100 has two waist or hip belts 715, and 716 that wrap around a user's hips or waist. Belts 715, 716 each have a padded area 710 that is attached to panel 103. Each belt 715 and 716 also has a built-in storage compartment 750, that can be opened or closed by a zipper 751. Belt 716 has a strap with a female connector, that connects to the male connector of the strap attached to belt 715. The length of the connected straps can be adjusted with a webbing slider 128 to be tighter or looser.

Each strap 146 and 145 is connected to shoulder strap 821 and 822, respectively. The lower end of strap 146 is connected to protrusion 155 and the lower end of strap 145 is connected to protrusion 156. Straps 145 and 146 are adjustable in length by use of a webbing slider 128.

Each panel 102 and 104 has an expandable container 760 that can hold a variety of objects such as bottles.

Referring to FIGS. 1-6, pack 100 has a first compression strap 142 connected at a first end at the interface between panel 103 and 102, preferably with stitching or bar tacks 136, and is connected at a second end to a male buckle 153. Male buckle 153 is connected to a female buckle 150 that is in turn connected to another strap 142 at one end. The other end of strap 142 is connected to pack 100 at the interface between panel 102 and 101, preferably with stitching or bar tack 136. An additional strap length is preferably provided, so that the length of strap 142 can be adjusted to provide more or less compression.

A second, identical strap 142, on the opposite side of the pack 100, has a first end that is connected to pack 100, preferably with stitching or bar tacks 136 at the interface between panel 103 and 104. The second strap 142 is connected at a second end to a male buckle 153. The male buckle 153 is connected to a female buckle 150, that is in turn connected to another strap 142 at one end. The other end of strap 142 is connected to pack 100 at the interface between panel 104 and 101 with stitching or bar tack 136. An additional strap length is preferably provided, so that the length of strap 142 can be adjusted to provide more or less compression.

The first and second compression straps 142 are located above handles 132.

Pack 100 has a third compression strap 143 connected at a first end at the interface between panel 103 and 102, preferably with stitching or bar tacks 136, and is connected at a second end to a male buckle 153. Male buckle 153 is connected to a female buckle 150, that is in turn connected to another strap 143 at one end. The other end of strap 143 is connected to pack 100 at the interface between panel 102 and 101, preferably with stitching or bar tack 136.

A fourth strap 143 identical to the third strap 143, is on the opposite side of the pack 100, and has a first end that is connected to pack 100, preferably with stitching or bar tacks 136, at the interface between panel 103 and 104. The fourth strap 143 is connected at a second end to a male buckle 153. The male buckle 153 is connected to a female buckle 150, that is in turn connected to another strap 143 at one end. The other end of strap 143 is connected to pack 100 at the interface between panel 104 and 101, preferably with stitching or bar tack 136.

The third and fourth compression straps 143 can be located below handles 132.

In some embodiments, first, second, third and fourth straps 142 and 143 are of a fixed length, and when they are connected via the male and female buckles 153 and 150, respectively, they provide compressive force or forces on the body 50 of pack 100.

In some embodiments, first, second, third and fourth straps 142 and 143 are of an adjustable length, and when connected via the male and female buckles 153 and 150, provide adjustable compressive forces on the body 50 of pack 100, based on how much length is removed from each strap. The more length that is removed, the shorter the straps become, and more compression is added. Accordingly, if length is added to the straps, compression is decreased. The compressive forces add additional rigidity to the pack 100 and allows a pet to sit up comfortably and more easily when carried in pack 100 and minimizes or prevents the pet from sagging in the pack 100.

Referring to FIG. 10, a first sternum strap 144 is connected or attached at a first end to shoulder strap 822 and at a second end to a male buckle 153. A second sternum strap 144 is connected or attached at a first end to strap 146 and at a second end to a female buckle 150. When the first and second sternum straps 144 are connected via the buckles 150 and 153, a user is provided with additional support and compression at the sternum or chest region. The straps 144 are adjustable so that the length can be increased or decreased to provide more or less compression.

In some embodiments, straps 141, 144, 142, 143, 145 and 146 are composed of nylon webbing, and can be 25 mm nylon flat twill webbing.

Referring to FIGS. 1, 2A, 2B, 8 and 12, a first zipper 119 is located between the interface of panels 104 and 101, and second zipper 119 is located between the interface of panels 101 and 102. A zipper pull is attached to each zipper 119. The first and second zipper 119 provide side entry and side exit points for the loading and unloading of a pet. Furthermore, the pet can be loaded and removed from the top of the pack 100 at lip 191, when the harness 160 or 161 is disconnected from the brace or kept connected and loosened. Providing multiple entry and exit points for loading and unloading a pet, provides a user multiple options that they can choose from based on their preferences and how their pet behaves. Some users may find it easier to open one or both of the side zippers 119 to load or unload their pet, and some users may choose to use the top of the pack 100 to load and unload the pet.

In a preferred embodiment, the method of loading the pet into the pack 100 is to unzip both zippers 119 on each side of the pack completely, open up or filet the pack 100 on the ground, place the pet on the interior surface of the back panel 103 in a prone position, fold the front panel 101 up onto the pet's back, zip up both zippers 119, buckle the side straps 142 and 143 on each side of the bag, buckle the strap 141 with the collar harness 160 or 161, and use all or some of the grab handles 132 or 134, alone or in combination to hoist the pack 100 with the pet onto a user's back. The straps 141, 142, 143 and 144 can be tightened and loosened as needed.

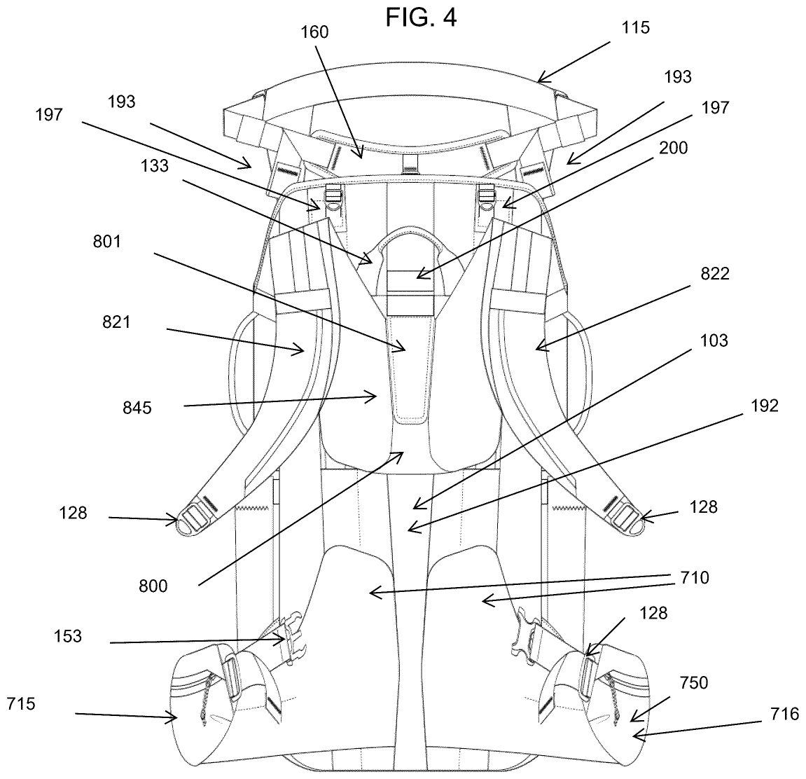

Referring back to FIG. 4, top handle 133 is shown. Handle 133 is connected to pack 100, preferably by stitching or bar tacks 136, near a top portion of panel 103 near lip 191 as shown. The outer material of the handle 133 can be a hollow tubular nylon or hollow neoprene, that is packed at the center portion with a cylindrical or rectangular EVA foam or padded insert. The insert when packed in the hollow casing of handle 133, can have bar tacks 136 and/or other stitching placed on either side of the insert and into the nylon casing to prevent the insert from moving off center when being used.

Referring to FIGS. 1-5, handles 132 and 134 are shown. The construction of handles 132 and 134 and attachment of the handles to pack 100, is identical, except for the location of the handles on pack 100 as described above and shown in the figures.

Handles 132 and 134 are connected to pack 100, preferably by stitching and/or bar tacks 136, to panels 101, 102 and 104 as shown. The outer material of the handles 132 and 134 can be a hollow tubular nylon or neoprene, that is packed at the center portion with a cylindrical or rectangular EVA foam or padded insert. The insert when packed in the casing of handles 132 and 134, can have bar tacks 136 and/or other stitching placed on either side of the insert and into the casing to prevent the insert from moving off center when being used. Box and cross stitches 135 are also used to reinforce the attachment of handle 132 and 134 to pack 100 as shown. Handles 132 and 134 are connected or attached to their respective panels or areas of the pack 100, preferably with bar tacks 136 and/or box and cross stitches 135 as shown in the figures and described herein.

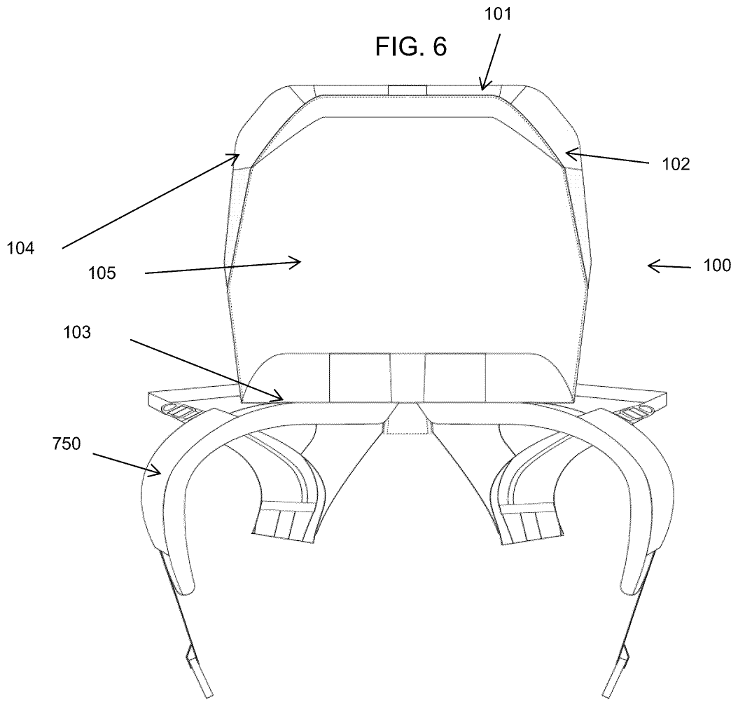

Referring to FIG. 6, the bottom panel 105 is shown connected or attached to panels 101, 102, 103 and 104. However, as described above, pack 100 does not need to be constructed with side, front, back and bottom panels, and can instead be a single unitary body 50 or even a combination of one or more panels with another panel.

Referring to FIGS. 1-9 and 12, panel 102 is connected, preferably by stitching or other methods known in the art, to panel 101 on a first end as shown in the figures. At the interface between panels 102 and 101 is zipper 119 that can be opened or closed to provide an entry or exit point into and out of the pack 100 for a pet. Zipper 119 can include a zipper assembly with a coil zip and automatic lock slider and zipper stop. In some embodiments, zipper 119 is a YKK zipper and zipper stop. Panel 102 can have a portion 108 that can be made of a different material than the rest of panel 102. Portion 108 can a breathable mesh material such as polyester spacer knit mesh, or other similar materials known in the art. Portion 108 allows the heat buildup within the body 50 to ventilate or dissipate out of pack 100 when the pet is carried in the pack. Panel 102 is connected, preferably by stitching or other methods known in the art, to panel 103 on a second end as shown in the figures.

Panel 104 is connected on a first end, preferably by stitching or other methods known in the art, to panel 101. At the interface between panels 104 and 101 is zipper 119 that can be opened or closed to provide an entry or exit point into and out of the pack 100 for a pet. Zipper 119 can include a zipper assembly with a coil zip and automatic lock slider and zipper stop. In some embodiments, zipper 119 is a YKK zipper and zipper stop. Panel 104 can have a portion 108 that can be made of a different material than the rest of panel 104. Portion 108 can be a breathable mesh material such as polyester spacer knit mesh or other similar materials known in the art. Portion 108 allows the heat buildup within the body 50 to dissipate out of pack 100 when the pet is carried in the pack. Panel 104 is connected on a second end, preferably by stitching or other methods known in the art to panel 103 as shown in the figures.

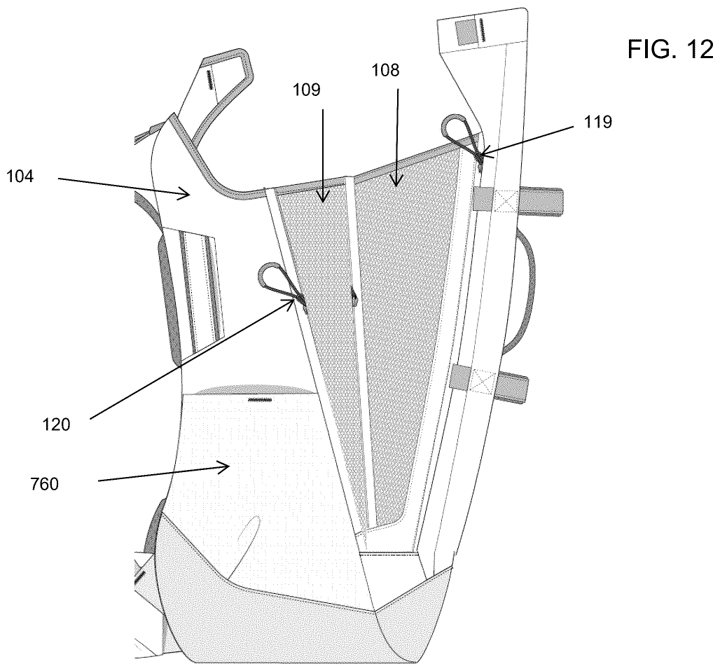

Both panels 102 and 104 have an expandable mesh portion 109, with identical properties to portion 108. Zipper 120 enables expansion and storage of the expandable portion 109, so that when zipper 120 is pulled up, portion 109 is folded and kept stored in the interior portion of the pack 100, thereby decreasing the capacity of the pack 100 as shown in FIG. 1. When zipper 120 is pulled down, expandable portion 109 is let out and increases the carrying capacity of pack 100 as shown in FIG. 12.

Referring back to FIGS. 1-9, panel 101 has an inner zipper guard on each side of the panel 101. When connected to panels 102 and 103, the zipper guard protects and covers zippers 119. Zipper guards can reduce or prevent animal hair, fur, or other debris from getting into the zippers 119 and can thereby ensure that the zippers maintain their function as the pack 100 is used.

Panel 103 has a portion 192 that is in contact with a user's back when worn. Portion 192 is made of a breathable material, such as polyester spacer knit mesh or 600D polyester, or 200D polyester spandex with four-way stretch.

In some embodiments, bottom panel 105 is a single layer composed of 600D or 900D nylon. Bottom panel 105 is a surface to rest the hind limbs of the pet when the pet sits upright in the pack 100. In some embodiments, bottom panel 105 can contain EVA foam.

Panels 101, 102, 103, 104 and 105 collectively form the main body 50 of pack 100 when connected together as shown in the figures.

Referring to FIG. 7, the interior of panel 103 is shown, having an interior surface 113, a pocket 164 for housing a portion harness 160. Interior surface 113 can be made of 210D polyester.

Referring to FIG. 8, an interior of side panel 102 is shown. Interior surface 114, which is the same for the interior of side panel 104 and 101 can be made of 210D polyester. Curvature 182 shows the pack 100 has a curved area that fits into a user's lumbar area on the spine, to provide a more ergonomic fit, along with dip 180 and curve 181 which generally follows the curvature of the human spine.

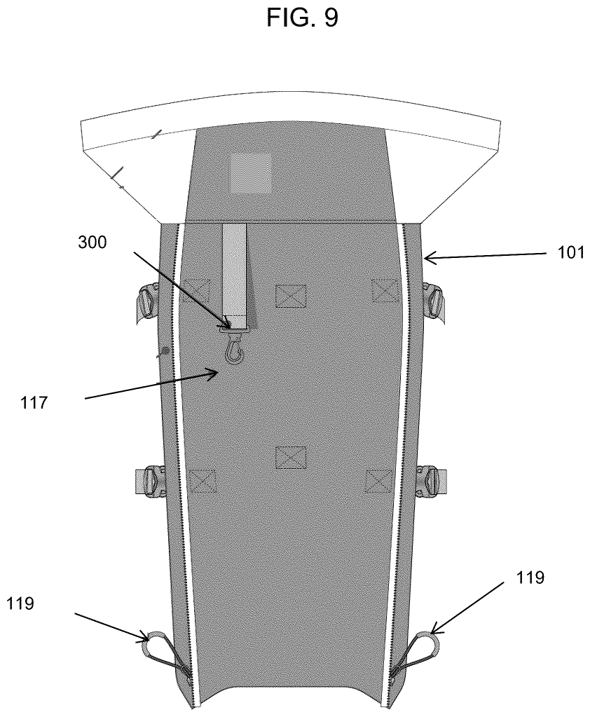

Referring to FIG. 9, an interior of panel 101 is shown. Interior surface 117 can be made of 210D polyester. The interior surface 117 of panel 101 has a collar clip 300 connected or attached by a strap to pack 100 at the interface between panel 101 and brace 115, preferably with stitching and/or a bar tack 136. Collar clip 300 is an internal clip that can connect to a pet's collar and ensure the pet does not leave the pack without first being disconnected from the clip 300. Collar clip 300 is located internally in the main body 50 and acts to prevent the animal from escaping the pack 100.

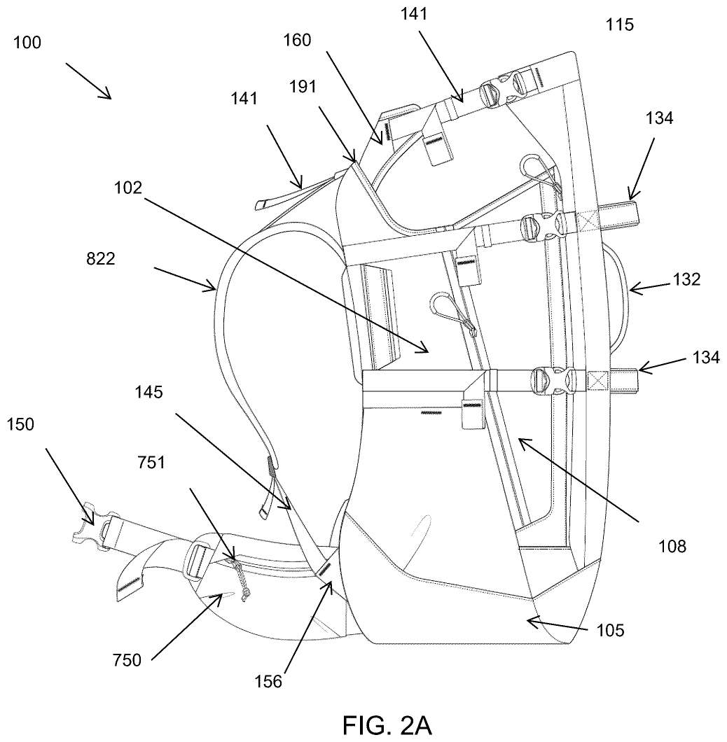

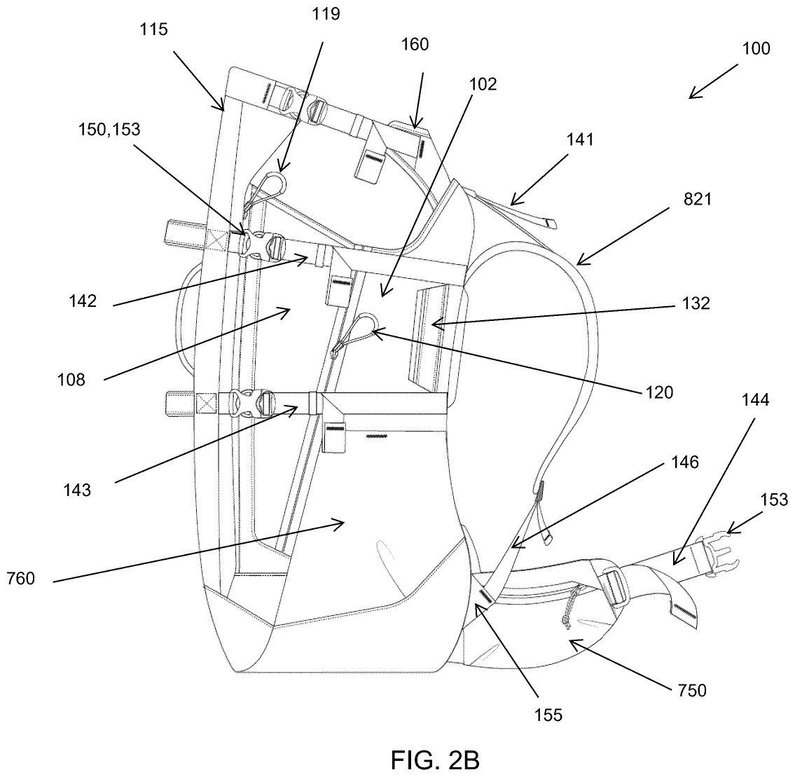

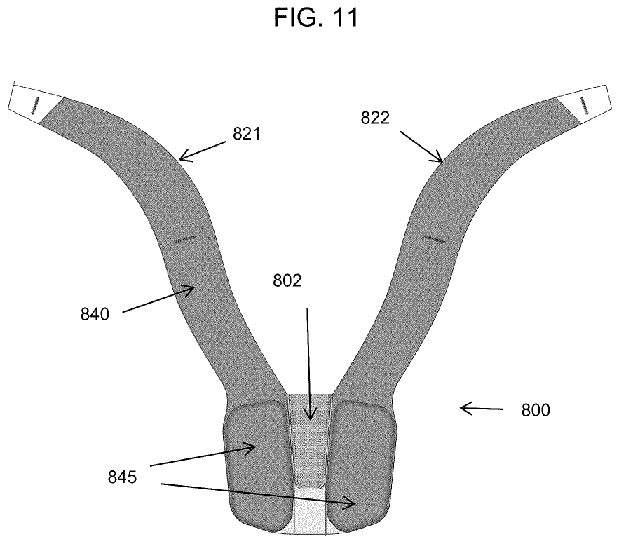

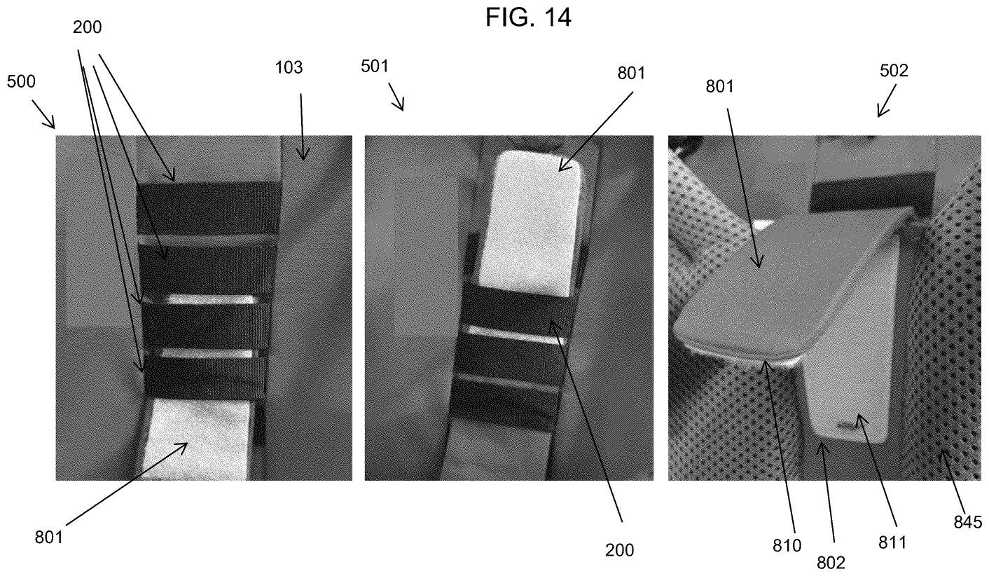

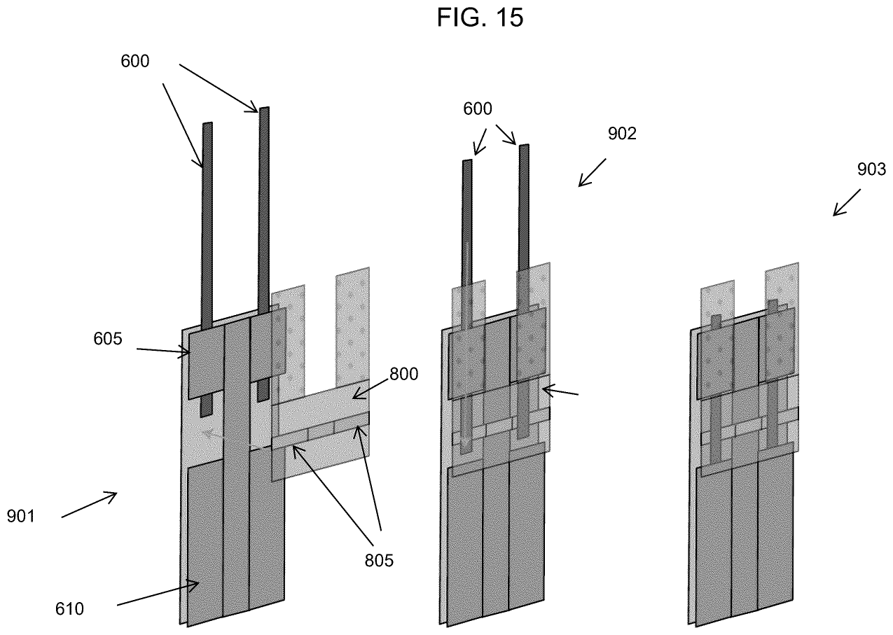

Referring to FIGS. 10 and 11, adjustable shoulder strap system 800 is shown. A user is able to attach system 800 to pack 100 as shown and described below in the description of FIGS. 14-16. System 800 has a base portion 803, onto which shoulder straps 822 and 821 are connected, by various means known in the art, such as stitching. Flap 801 is connected to rectangular portion 802 and portion 802 is connected to base 803 by stitching. Flap 801 is foldable about the crease line between flap 801 and portion 802. Both flap 801 and portion 802 are able to be moved up and down about the connection point between 802 and 803. Flap 801 is able to be folded about the crease line between 801 and 802. Channels 805 are sewn into base 803 as shown to enable connection of system 800 to pack 100 via insertion and threading through of rigidity bars 600 as shown and described below with regards to FIG. 15. Shoulder straps 821 and 822 can have reinforced stitched areas 137 for connection of straps 141 that can connect to pack 100 at a top portion of panel 103 as shown in FIGS. 2A and 2B. When connected, straps 141 provide added support and rigidity to system 800, when a user places pack 100 on their back.

Referring to FIG. 11, the bottom portion of system 800 is shown, which makes contact with a user's shoulders and upper body. The bottom surface 840 is made of a breathable material such as a mesh fabric. Areas 845 are extra padded areas of system 800, that contact a user's back, and can be filled with foam, such as EVA foams of varying density or thickness. Straps 821 and 822 can be filled with an EVA foam, and areas 845 can have an additional extra layer of EVA foam for cushioning. The bottom portion of 802 can have a hook or loop fastener attached.

Referring to FIGS. 13A and 13B, chest harness 160 is shown. Chest harness 160 has a top layer 175 and a bottom layer 169 fixed together, preferably with stitching and/or bar tacks 136. As the strap 141 is attached by stitching to harness 161 on either side as shown, any adjustments to the harness 160 will be made by adjusting the length of strap 141 on either side of harness 160. The top of harness 160 is preferably curved to help contour and secure the harness 160 to a pet's chest and/or neck area when connected to pack 100 as described above. The bottom of harness 160 has a protrusion 170 can be held in place within pocket 164 of the interior of panel 103. Harness 160 can be connected or attached to pack 100 with male and female buckle attachments 153 and 150. In some embodiments, top layer 175 can be made of 300D nylon, or 200D polyester spandex mesh that has a four-way stretch. In some embodiments, bottom layer 169 is made of a breathable material such as a fabric mesh.

The adjustable shoulder harness is designed to accommodate a large range of torso heights, so that it can fit different sized people. In some embodiments, the protrusion 170 has a hook or loop attachment, attached to the layer 169, and the inner area of pocket 164 has also has a complementary hook or loop attachment on the inner surface of the pocket 164 so as to be removably attachable to the hook or loop attachment on layer 169 of harness 160. In this embodiment, the harness 160 can be secured at different heights to the backpack 100 via the removable connection to pocket 164, and can be vertically height adjusted depending on how deep the protrusion 170 is placed into pocket 164, before the hook and loops attach to one another. The hook and loop attachments also prevent the harness 160 from inadvertently being disconnected from the pocket 164, and therefore backpack 100.

Referring to FIG. 13C, the embodiment of harness 161 is shown. Harness 161 has a top layer 166 and a bottom layer 167 fixed together, preferably with stitching and/or bar tacks 136, and can have double bar tacks 136 per side for added strength. As the strap 141 passing between the top layer 166 and bottom layer 167 is fixed, any adjustments to the harness 161 will be made by adjusting the length of strap 141 on either side of harness 161. Harness 161 is preferably curved to help contour and secure the harness 161 to a pet's chest and/or neck area when connected to pack 100 as described above. Harness 161 can be connected or attached to pack 100 with male and female buckle attachments 153 and 150. In some embodiments, top layer 166 can be made of 200D polyester spandex mesh that has a four-way stretch. In some embodiments, bottom layer 167 is made of the same material as the main exterior fabric of pack 100 such as 600D or 900D nylon.

Referring to FIG. 14, steps 500-502 are shown in which shoulder strap system 800 is connected to panel 103 of pack 100. In step 500, flap 801 is threaded through at least one strap 200, and the straps 200 are connected to the center of panel 103 through various means such as stitching. In some embodiments, at least one strap 200 is connected to panel 103. In some embodiments, at least two straps 200 are connected to panel 103. In some embodiments, between three to seven straps 200 are connected to panel 103. Where flap 200 is threaded through a lower strap 200, the shoulder strap system 800 will be attached lower on panel 103. Where flap 200 is threaded through a higher strap 200, the shoulder strap system 800 will be attached higher on panel 103, thus providing a user with an adjustable height system to adjust the location of the shoulder straps relative to the pack 100. Step 501 shows flap 801 being threaded through the second topmost strap 200 on panel 103. In step 502, once the flap 801 is threaded through the desired strap 200, it is folded back on itself so that a hook or loop fastener 810 on its bottom surface is attached to a hook or loop fastener 811 on the top surface of portion 802. Once the hook and loop fasteners are joined together, the shoulder strap system is connected to panel 103 of pack 100.

Referring to FIG. 15, steps 901-903 are shown in which shoulder strap system 800 is connected to panel 103 of pack 100, by being interlocked with rigidity bars 600 that are placed within panel 103. Pack 100 have openings 197 near the top of panel 103, as shown in FIG. 4, that allow a user to insert a rigidity bar 600 through each opening and into the interior of panel 103. In some embodiments openings 197 have covers that can be sewn closed after rigidity bars 600 are added so as to prevent the bars from being removed from the backpack 100 after the bars are inserted into the backpack. In some embodiments the openings 197 have covers that are able to be secured and unsecured by various means known in the art to the backpack 100 to enable a user to insert or take out the rigidity bars 600 at will but prevent the bars 600 from inadvertently leaving the backpack 100. Step 901 shows two rigidity bars 600 being inserted into panel 103, and through channels 605 within panel 103. Step 902 shows bars 600 being threaded through channels 805 of system 800, and then in step 903 through channels 610 within panel 103. Once rigidity bars 600 are fully inserted into panel 103 as shown in step 903, shoulder system 800 is connected to pack 100 by being interlocked with the rigidity bars within panel 103. Rigidity bars 600 can be made of various rigid and sturdy materials such as but not limited to, metals and hard plastics. In some embodiments, bars 600 are made of iron, or steel or aluminum. As described above, shoulder system 800 is connectable to pack 100, by both connection of flap 801 and strap 200, and by interlocking with rigidity bars 600 with channels 805. The rigidity bars 600 distribute the weight to the hips of the user, and the chest harness adjusts to fit a range of different sized dogs.

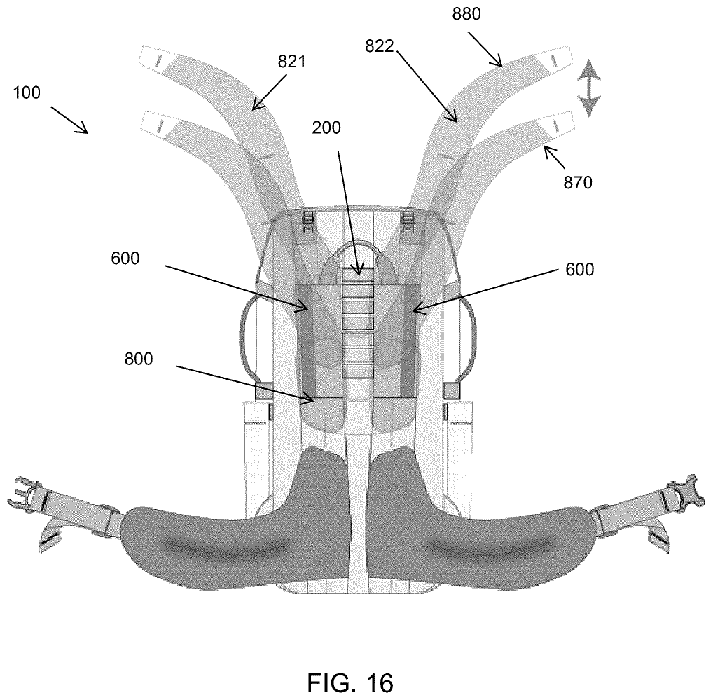

Referring to FIG. 16, shoulder system 800 is shown connected to pack 100, and shows that when flap 801 is threaded through different straps 200, the height of system 800 can be adjusted from a higher height 880 to a lower height 870 depending on the strap 200 that flap 801 is threaded through.

In some embodiments, the materials of the outer or exterior portion of pack 100, except where otherwise stated above, are made with a resilient and tear resistant material such as 300D nylon ripstop, 600D or 900D nylon. In some embodiments, the various parts of pack 100 be made of a variety of materials such as but not limited to, 300D nylon ripstop, 210D or 200D polyester spandex with a four-way stretch, and/or 600D nylon, 900D nylon air mesh, diamond mesh, stretch weaves, Neoprene, EVA foams of varying thickness (including 8, 5 and 12 mm). In some embodiments, the materials of the inner portion of pack 100, except where otherwise stated, can be made with a rip resistant material such as 210D polyester, or 210D honeycomb Rip-Stop lining.

The pack 100 offers increased ergonomics and ease of use. The contoured shaping of the shoulder straps enables an ergonomic fit. All touch points on pack 100 provide a cumulative benefit to improved ergonomics and interface. The pack 100 can offer an increased buckle size (in some embodiments a 25 mm side release buckle) for easier use and handling, the thermoplastic polyurethane (TPU) pullers for easier zipper interface and grabbing, the structured handles 132 and 134 (with foam reinforcement) for ergonomic handling, and semi-shaped and contoured shoulder straps 821 and 822 with the sternum strap 144 offer improved fit and comfort for carrying loads. These elements alone or in combination can provide an improved interface and ergonomics for a user. In some embodiments, the male and female buckles 153 and 150 can be color coordinated buckles for visual identification. Panel 103, 104 and 102 can be shaped to ergonomically fit the curvature of the human spine, thereby increasing comfort. The height adjustable shoulder strap system enables a user to adjust the height of shoulder straps as needed, and thereby increases a user's comfort. The rigidity bars offer increased rigidity to the pack 100, and thereby reduce fatigue for both the user and the pet when being carried in the pack. This is especially useful for medium to larger breed pets.

Through the materials, fit, and construction, the backpack 100 provides a semi-rigid to rigid support structure for both the animal and user. The main fabric can provide rigidity to maintain shaping throughout each of the panels 101, 102, 103, 104 and 105 alone, all together or in any combination. Placement of a semi-rigid substrate (such as polyurethane (PU) and ethylene-vinyl acetate (EVA)/PU or EVA) in the fabric panels offers additional support, protection, and comfort for the animal. Placement in the panels can be between an outside external surface and an inside interior surface, or an upper and lower surface. The main reinforced structures in the backpack are the panel 103 and the panel 101. These “structured” areas can be connected via the side compression straps 142 and 143 to compress the side panels 102 and 104 which are “unstructured” to allow for better compression and fit. Panel 103 being located between the user and the animal, provides not only a cushion for the user, but also provides the same amount of functionality and cushion back to the animal. The combination of these elements on panel 103 allows for the improved fit and comfort of the animal and acts as a semi-rigid to rigid structure to encapsulate the animal securely and provide enough structure to comfortably support the spine and neck of the animal. The side compression straps 142 and 143 also aid in the optimized fit of the animal against the user and panel 103. The compression straps allow for additional securement of animal to be more efficient and ergonomic in load bearing and sway prevention (side to side movement), bringing the weight of the animal closer to the user to allow for improved load carrying efficiencies. In some embodiments, the combination of these elements works together to provide a more secure and comfortable fit and carrying experience for the animal and the user. In some embodiments, the shaping and contouring of the fabric panels 101, 102, 103, 104 and 105, or main compartment 50, are optimized around the unique measurements and build of a pet to provide specific comfort and improved fit for the pet, such as a canine.

It should also be noted that the terms “first”, “second”, “third”, “upper”, “lower”, and the like can be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes can be made, and equivalents can be substituted for elements thereof without departing from the scope of the present disclosure. In addition, many modifications can be made to adapt a particular situation or material to the teachings of the disclosure without departing from the scope thereof.

Therefore, it is intended that the present disclosure is not limited to the particular embodiment(s) disclosed. The foregoing examples should not be construed as limiting and/or exhaustive, but rather, as illustrative use cases to show an implementation of at least one of the various embodiments of the present disclosure.

1. A backpack for carrying animals comprising:
a main body defining a carrying compartment;
an adjustable shoulder strap system including a first shoulder strap and a second shoulder strap, the shoulder strap system being detachably connected to a rigidity system that is on a front portion of the main body;
a brace connected to a rear portion of the main body; and
a harness connected to the brace forming at least one hole between the harness and an upper lip portion of the main body.

2. The backpack according to clause 1, wherein the rigidity system includes rigidity bars.

3. The backpack according to clause 1, wherein the main body has a first zipper and a second zipper disposed on a first side portion and a second side portion, respectively, of the main body, and wherein the first side portion is opposite the second side portion and the front portion is opposite the rear portion.

4. The backpack according to clause 1, wherein the harness is height adjustable.

5. The backpack according to clause 1, wherein the shoulder strap system is height adjustable.

6. The backpack according to clause 1, wherein the harness can be removably attached to the main body.

7. The backpack according to clause 1, wherein the first side portion is expandable.

8. The backpack according to clause 1, wherein the second side portion is expandable.

9. The backpack according to clause 1, wherein the main body has at least one carrying handle.

10. The backpack according to clause 1, wherein the backpack has a hip belt.

11. The backpack according to clause 1, wherein the harness and brace together form an adjustable inner diameter.

12. The backpack according to clause 2, wherein the rigidity bars are made of metal.

13. The backpack according to clause 2, wherein the rigidity bars are made of aluminum.

14. The backpack according to clause 10, wherein the hip belt contains compartments for the storage of items.

15. A method of loading an animal into the backpack of clause 3, comprising the steps of:
fully opening the first zipper and the second zipper on the first and second side portions folding back the rear portion to open the backpack to separate the rear portion from the first side portion and second side portion;
placing the animal onto an internal surface of the front portion and into the carrying compartment;
closing the first and second zippers; and
placing limbs of the animal through the at least one hole so that the limbs protrude out of the backpack.
